(19) United States
(12) Patent Application Publication
(10) Pub. No.: US 2009/0094660 A1
(43) Pub. Date: Apr. 9, 2009

(54) Method and apparatus for configuring a device from a network

(76) Inventors: David John Weaver, Noblesville, IN (US); David Jon Nicoson, Indianapolis, IN (US); Dhanuskodi Manikandan, Westfield, IN (US)

Correspondence Address: Robert D. Shedd;Thomson Licensing LLC, PO Box 5312, PRINCETON, NJ, 08543-5312, US

(21) Appl. No.: 11/990,896

(22) PCT Filed: Jun. 16, 2006
(86) PCT No.: PCT/US2006/023620

§ 371 Date: Feb. 22, 2008

Related U.S. Application Data
(60) Provisional application No. 60/711,836, filed on Aug. 26, 2005.

(51) Int. Cl. H04N 7/173

(52) U.S. Cl. 725/131

(57) ABSTRACT

An IP settop box for use in a network is described, including the apparatus and a method for updating the apparatus in a network. The method includes interfacing the device to a network, launching a service related to interfacing the network to the device, determining if the service is operating properly, requesting information related to the service if it is not operating properly, and updating the service using the requested information without restarting the device. The apparatus includes a network interface for communicating with a network including a request for an update related to a service and an updated value related to a service, a memory for storing a value related to the service, and a processor operatively coupled to the network interface and memory for managing the update related to the service in the apparatus by allowing a change to the value in the memory without restarting the apparatus.

This application claims the benefit under 35 U.S.C. § 119 of a provisional application 60/711,836 filed in the United States on Aug. 26, 2005.

### FIELD OF THE INVENTION

The present invention relates generally to a network connected device. More specifically the present invention relates to configuring an operating system for a network connected device using information provided by the network.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Internet accessibility has continued to expand and include more and more types of devices utilizing more and more media. A customer can now access the internet not only over through conventional phone line service, but also through a cable or satellite network, or over a cellular or local wireless network. Additionally, the phone line service has been expanded to allow digital subscriber line (DSL) service.

The types of services available over the internet have also expanded to include not only website surfing and email, but also instant messaging and music and video delivery. Real time services including voice and video have also become more prevalent as the service delivery and access speeds have increased with the advent of broadband networks. Many of these advanced features are offered as additions to ordinary internet access as a way to generate additional revenue for the service providers.

The issue underlying many of these new services is the issue of network control. The service providers prefer to manage the network by restricting and controlling access to it. Most service providers supply the premises equipment that is used with their network to the customer. The service providers include custom software with the equipment to permit access to the network. More importantly, the specially tailored software allows the service provider the ability to better manage access to the advanced features provided by the service provider.

Companies responsible for manufacturing the premises equipment used in the customer's home are faced with the task of how to most efficiently manufacture equipment that ultimately must be tailored for each individual service provider's network. In some cases, in order to allow the service provider the ability to provide specialized software in the premises equipment, the premises equipment downloads the software from the service provider over the network after premises equipment is installed in the home. Future updates are then downloaded and installed at later times and as needed.

Software operating systems used in premises equipment have limiting issues when used in a restricted environment with respect to private networks. Normal internet services such as time retrieval and remote management tools are often difficult to install after the operating system is running the premises equipment. One of the core problems is evident in the fact that a manufacturer would prefer to know the information about the service provider's network when the operating system is initially installed prior to delivery. All of the information necessary to configure the operating system may not be available because some networks are intended to have some level of secrecy and the information may also require periodic updates. Further, downloading important aspects of an operating system such as basic services may often prove inconvenient. These services often have protection in order to prevent illegal operation, or when the new information is supplied the equipment may malfunction without all proper information in place.

Two common approaches to providing these critical services after initial installation is to either download the entire operating system to the premises equipment or to download the specific information for the services. In either approach, the premises equipment will restart or re-boot in order to provide the new information into the operating system. Re-booting the premises equipment is usually required if the critical services were not launched successfully during the initial booting. The services cannot later be launched because the memory allocation for the service was not made during the initial booting. Further, re-booting the premises equipment after downloading the new operating system information takes away operational time from both the network and the customer and in some cases may occur at a time that is not convenient for the customer. Therefore there is a need to request and receive critical network information and to process the information in the customer premises equipment in an efficient manner.

### SUMMARY OF THE INVENTION

The present invention relates to a method and apparatus for updating a device in a network. The method includes interfacing said device to a network, launching a service related to interfacing the network to the device, determining if the service is operating properly, requesting information related to the service if it is not operating properly, and updating the service using the requested information without restarting the device. The apparatus includes a network interface for communicating with a network including a request for an update related to a service and an updated value related to a service, a memory for storing a value related to said service, and a processor operatively coupled to the network interface and memory for managing the update related to the service in the apparatus by allowing a change to the value in the memory without restarting the apparatus.

### BRIEF DESCRIPTION OF THE DRAWINGS

In the drawings:

FIG. 1 is a block diagram of an exemplary system using the present invention.

FIG. 2 is a block diagram of an embodiment of the present invention.

FIG. 3 is a flow chart of an embodiment of the present invention.

FIG. 4 is a flow chart of another embodiment of the present invention.

FIG. 5 is a flow chart of a further embodiment of the present invention.

The characteristics and advantages of the present invention may become more apparent from the following description, given by way of example.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

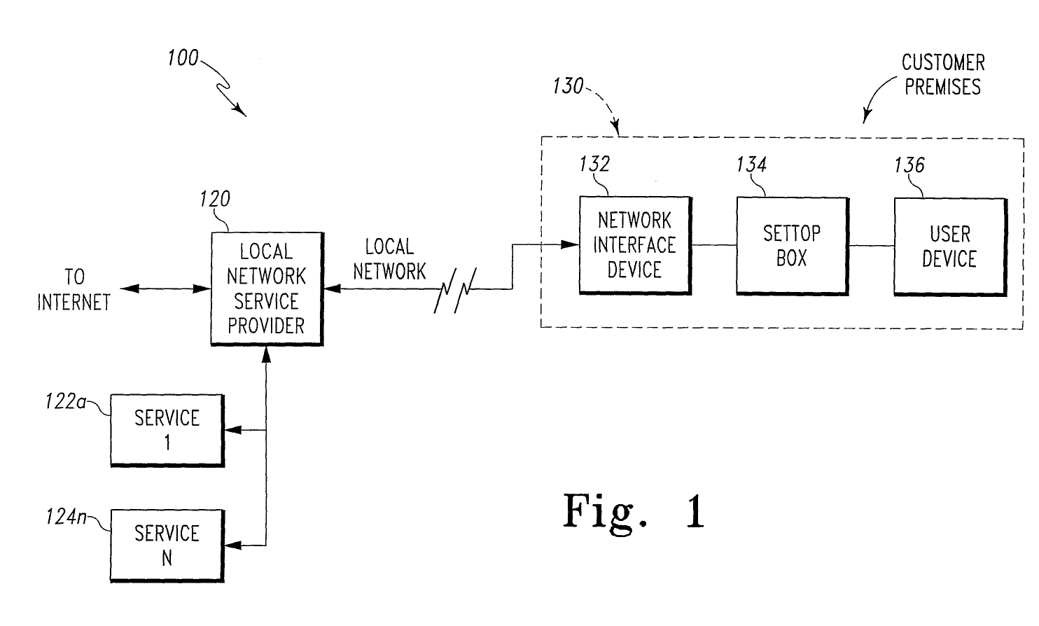

Turning now to FIG. 1 a block diagram of an exemplary system 100 using the present invention is shown. The diagram shows a network connecting a service provider 120 to one or more customer premises 130. A local network service provider 120 maintains a connection to the internet through an appropriate network backbone, such as a fiber optic line. The local network service provider 120 also maintains an interface to a local network. In a preferred embodiment the local network service provider operates over a DSL network on a phone line. In this manner, the local network service provider acts as a gateway between the local network and the internet. The local network service provider 120 also operates, maintains, or interfaces to one or more services 122a-122n. These services may include a local phone service, video-on-demand service, community broadcasting service, or the like.

The local network may connect into one or more customer homes or customer premises. For simplicity, only one connection is shown as customer premises 130. Within, or at, customer premises 130, a network interface device 132 provides an interface to the local network for communication with the local network service provider 120. The network interface device 132 is used to receive and transmit signals on the phone line. The network interface device 132 may also provide the demodulation of a received signal and modulation of a transmitted signal. The network interface device 132 also provides any translation needed to interface the signals from the local network to a format required by settop box 134, such as internet protocol (IP) format. Settop box 134 may convert the supplied signal from a format such as IP format into audio and video signals and provide these audio and video signals to a user device 136. An exemplary user device 136 may be a television or video cassette recorder, a computer, computer peripheral, or the like.

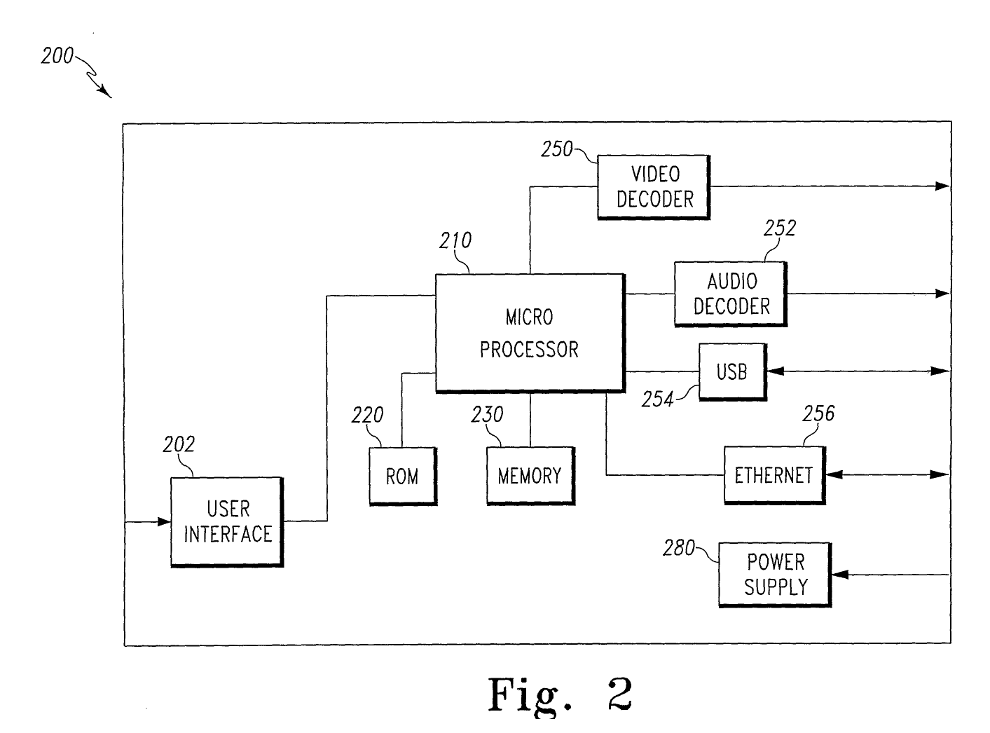

Turning now to FIG. 2, a block diagram of an exemplary settop box 200 utilizing the present invention is shown. The settop box 200 as described is often referred to as an IP-STB 200. The block diagram may also represent circuits associated with operations associated with an IP-STB 200 but the circuits may be present within a larger structure such as a video display receiver.

A signal in IP format is communicated between the network interface device 132 and the IP-STB 200 through ethernet block 256. The ethernet block 256 provides the physical interface in the form of a connector for cabling between the network interface device 132 and the IP-STB 200 as well any specific signal conditioning needed to interface to the network interface device 132.

Ethernet block 256 provides one of the communication interfaces to the IP-STB 200. In addition, the IP-STB 200 includes a USB block 254 that may also provide communication to external devices. The network interface device may alternately use either of these interfaces for its primary communication interface. The IP-STB 200 may also utilize the USB block 254 for auxiliary communications. For instance, the USB block 254 may allow connection to a computer or a computer related device such as a printer. Other communications interfaces may also be provided as known by those skilled in the art.

The ethernet block 256, along with the USB block 254, connects to the microprocessor 210. The IP signal passed through the ethernet block 256 is provided to the microprocessor 210. The microprocessor 210 may be of a standard type such as that found in many home computers. The microprocessor 210 may contain all the necessary interface circuits internally, or in some applications, the microprocessor 210 may use companion circuits such as a memory controller and input/output (I/O) controller, not shown, depending on performance and architectural requirements.

The microprocessor 210 processes the IP signal into packets of audio and video data and may also decode audio and video data packets into individual digial audio and video data streams. Additionally, the microprocessor 210 parses out any identifier tags and control information that the IP-STB 200 uses during operation. Microprocessor 210 also provides communications back to the network through network interface device 132 via Ethernet block 256. The communication from the microprocessor 210 may primarily consist of command and control information, user interface updates, and device registration information for security and maintenance.

A read only memory (ROM) 220 is connected to the microprocessor 210 and contains information that may be provided during assembly by a product manufacturer. The ROM 220 also contains control code that is executed by the microprocessor 210 in order to process the signals. For instance, the ROM 220 contains boot software for starting the microprocessor 210 and also contains values associated with any initial services that are required for operation on the network.

A memory 230 is connected to the microprocessor 210, and is used by the microprocessor 210 for storing code instructions for the operating system, values such as pointers to memory addresses used by the operating system, any updates to the operating system, and any intermediate values generated during signal processing. The memory 230 may include one or more types of random access memory (RAM), or may include a hard disk drive. The memory 230 may also be segregated into several memory subcircuits in order to optimize operation. In one embodiment, the operating system may be stored in flash memory, used for long term storage but still permitting modification. The ROM 220 may direct the microprocessor 210 to execute instructions starting at some memory location in the flash memory. The flash memory in memory 230 may then contain commands to retrieve certain values from a section of the RAM in memory 230. The remaining RAM in memory 230 may be used as a temporary storage for buffering and intermediate processing of the incoming received signal.

The microprocessor 210 provides the converted video and audio program streams to video encoder 250 and audio encoder 252. Video encoder 250 and audio encoder 252 convert the video and audio program streams into video and audio signals. The video and audio signals may be analog signals. In one embodiment, the video signal is a composite video supplied through a phono jack, and the audio signal is a left and right analog signal supplied through two other phono jacks. The microprocessor 210 may also provide the digital video and audio program streams to separate interfaces, not shown, for use with external devices.

A user interface 202 is provided for controlling IP-STB 200 through operation of microprocessor 210. In one embodiment, the user interface is an infra-red (IR) receiver that receives signals from a remote control, not shown. A user inputs the desired control function on the remote control. The remote control transmits the signal which is received by user interface 202. The user interface 202 processes the signal and provides the processed user interface signal to the microprocessor 210. Power to operate all of the circuits is supplied from power supply 280, which is connected through a power cable to an external wall outlet.

The IP-STB 200 may also utilize several of levels of security. The operating system is typically protected only to a minimal level through a series of check sums that primarily protects against corruption of the instruction set. Internal security of data provided from the network is managed through a digital rights management protocol available as part of most operating systems. The management protocol may also be authorized by the service provider through the network. All other security information and protocol may be provided by the service provider over the network.

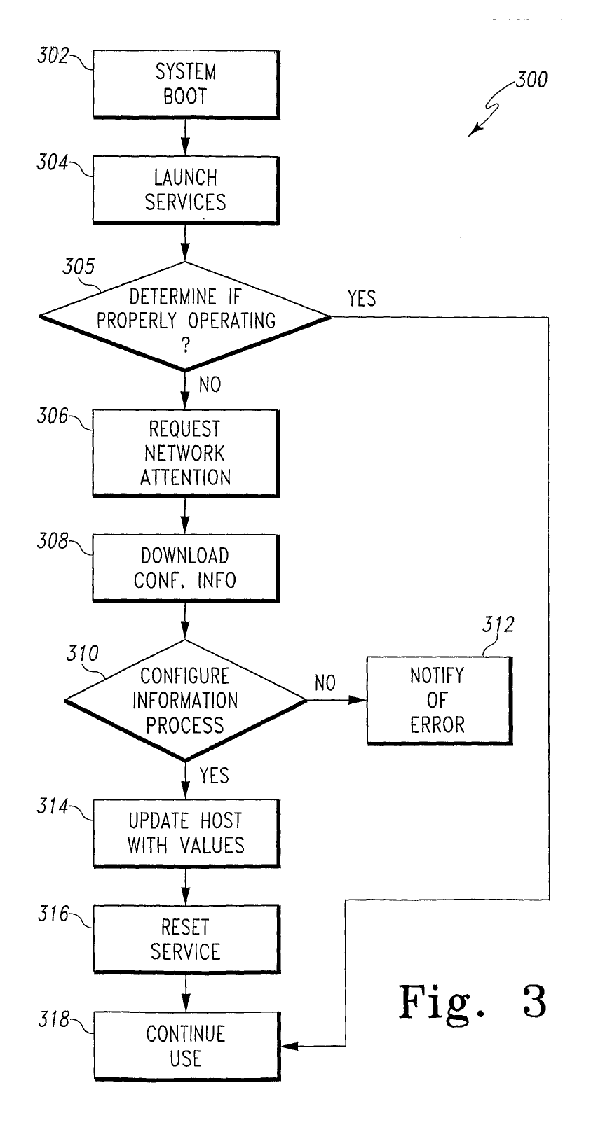

Turning to FIG. 3, a flow chart illustrating an embodiment of a process 300 of the present invention is shown. At step 302, the IP-STB performs an operating system initialization or boot. A system boot may be executed when the IP-STB 200 is initially powered on, or when the IP-STB 200 is connected or reconnected to a network. The operating system initialization also may contain an initial interfacing of the IP-STB 200 with a network, in order to establish that the IP-STB 200 is requesting network attention and inclusion on the network. Additionally, this step may not be present if the IP-STB 200 is in normal operation and updates to the operating system are provided by the network. As described previously, the code for initializing or booting the operating system is typically stored in the ROM 220, and the operation system code, often called the static code, and any updates, often called the dynamic code, may be stored in memory 230. After the ROM code is executed, the static code is executed by the microprocessor 210. At step 304, code is executed that launches services associated with operation of the IP-STB 200 including services associated with internal memory or interface management, time management, and network management. The services associated with network management may be launched but may not operate properly due to insufficient or incorrect network information being present at the startup. However, it is important, as will be described subsequently, that the network services launch in order to properly reserve and allocate the resources such as memory for the network service. It should be noted that the failure to launch the services will often force the IP-STB 200 to re-boot once the correct information is received. As previously discussed, rebooting or restarting the IP-STB 200 may waste network bandwidth and may be inconvenient for the user.

Further, at least one of the launched services is preferably capable of determining if other launched services, and in particular, services associated with the network, have been launched and/or are operating properly. Then, at step 305, a determination is made as to whether the services are operating properly. If the services are operating properly then normal use may continue at 318.

Next at 306, if any services are not operating properly, code is executed that requests the IP-STB 200 to notify the local network service provider and request information from the network server. The notification step may include providing the network service provider with necessary registration information such as the model number and serial or identification code of the IP-STB 200.

At step 308, the IP-STB 200 receives information from the network regarding specific network configuration information. The information may include information specific to the provider's operation of the network such as identifiers for locations of servers used by the provider. At step 310, the microprocessor 210 determines if the configuration information is correct. If the information is correct, then at step 314, the values that have been stored in memory are replaced with the newly acquired values. If the information is not correct, at step 312, it provides a notification that an error has occurred. Notification may be performed in a number of ways. For instance, after a specific period of time, for instance 90 seconds, the IP-STB 200 will execute a re-boot sequence. The IP-STB 200 may also notify the network service provider that service assistance may be needed.

After the values are updated, at step 316, the code in the IP-STB 200 executes an update procedure for any services that will be using the newly received information. Each affected service may require a separate and unique update depending on, for instance, the requirements of the operating system or the manner of operation of the service. Finally, at step 318, the IP-STB 200 resumes normal operation if operation was briefly interrupted. Additional steps, not shown, may be necessary for checking that all the downloaded information has properly updated the services, and that all the services are functioning properly after updating.

Some operating systems may include the ability to allow dynamic configuration while other operating systems may severely restrict this ability. The main issue in these restricted operating systems revolves around the issue that a service is started immediately upon boot and the operating system reads a system registry of memory locations and values at that time for all configuration values. The Network time Protocol (NTP) and Simple Network Management Protocol (SNMP) features are individual services associated with network communications and are restricted according to the operating system requirements. Each of these services is important to the operation of the IP-STB 200. The NTP service establishes the operating time functions and eliminates the need to use a battery to maintain time. The SNMP service is important for establishing secure communications between the IP-STB and the network. The present invention effectively allows these services, and services with similar restrictions, to launch during initial startup and initially operate, even if all the necessary data is not initially available. The parameters used by the services may be changed or updated after initial startup of the operating system has begun without requiring a complete reboot.

The present invention first requires that information be sent to the device from a network, such as the local network used by a service provider. Once the service provider-defined information is received over the network, the device's memory, including the operating system registry, is updated and the services are updated allowing use of the new values. The information related to these services may be included over the provider networks via a protocol such as Dynamic Host Configuration Protocol (DHCP) that may also include options as well as specific contents of a configuration file. In a preferred embodiment, a standard DHCP option (number 42), as defined by internet Request For Comment #2132 (RFC2132), may be used to communicate the NTP server Internet Protocol (IP) address.

Retrieving network specific information for the operation system services should preferably occur at the earliest time of the system starting up. For example, the retrieval of network specific information may occur during the time the IP-STB is establishing an IP address with the network service provider. When an IP address is assigned to a system on a network, based on the options supported by the provider, options data may be included in the packet. The options data may include, for instance, the needed NTP address. Additional capability in the DHCP options may also define a server and location to get a configuration file containing additional new information. Included in that information may be several values used by the SNMP service described later.

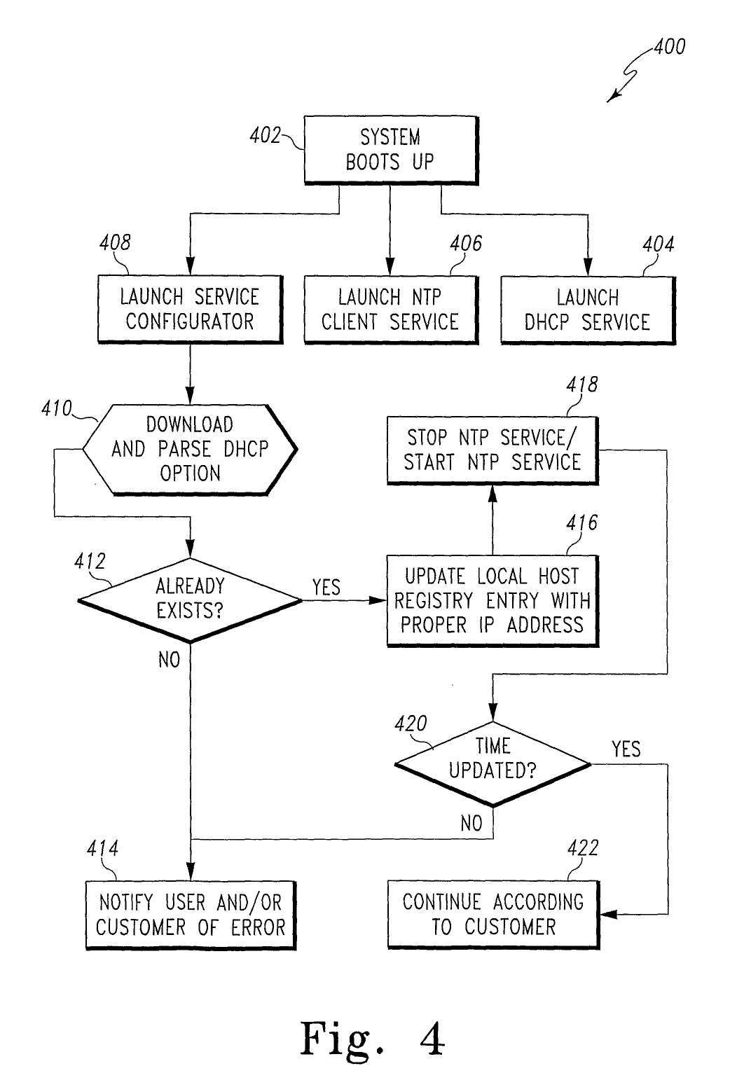

Turning to FIG. 4 a flow chart illustrating another embodiment of a process 400 of the present invention is shown. FIG. 4 illustrates a process for updating the NTP service. The service will use information in the system registry to periodically synchronize the time used by the operating system in operation of the IP-STB 200. The time is synchronized by contacting the server for the NTP service, as defined in a memory location in the registry. Additionally, the operating system may require a full and valid, though not necessarily operational, Domain Name System (DNS) name in the registry to launch and maintain the NTP service.

The flow chart starts from initial device turn-on, however the flow chart may also accommodate conditions where services are already launched and running. At step 402, the IP-STB 200 begins an initial boot sequence. The boot sequence results in the launching of several services at step 404, 406, and 408, including the DHCP service, the NTP client service, and the service configurator respectively. The DHCP service sets up the IP processing stack and includes the IP address used in operation. The NTP service provides the system time to the IP-STB 200. The IP-STB 200 may use time for operational validity and for event scheduling and management. The service configurator is a resident service in the IP-STB 200 for managing operation and communications with the network. The configurator reads the options values returned from the network, updates the values and manages the updates. The configurator is also responsible for determining whether the services launched are properly operating. For instance, the configurator may initially determine that the SNMP service has launched but will not successfully operate until further information is downloaded from the network.

The NTP service requires a domain name in order to contact the server for proper time updates. Unfortunately, a direct mapping of the domain name to an IP address may not be possible within the limitations of the operating system. In order to overcome this limitation, a static name is placed into the local host table registry entry at build time with a “stub” IP address and the default NTP service is initially configured to use that name. A “stub” IP is address is generally an IP address that is recognized as a valid IP address by the service but does not result in proper operation of the service. For example, a “stub” IP address of all zeroes may be considered a valid, but unused, address. However, when the service attempts to access the domain through this address on the network, no valid data regarding the NTP service will be returned. In this manner, the NTP service may be launched and all allocations of resources and memory will be performed by the operating system, but the system clock will not be properly updated.

Next, at step 410, the service configurator requests and receives a download from the network containing information based on providing a DHCP option 42 request. At step 412 the new information is compared to information already in the IP-STB 200. If an error is determined, at step 414, the user is notified of the error.

If no errors are determined then, at step 416, the old IP address stored in memory and associated with that static name is replaced with the new value. Next, at step 418, the NTP service is stopped and immediately restarted. When the NTP service is immediately started again, the NTP service reads the same registry entries to contact the server using the same static name as used originally. After the updated information is entered however, the operating system, through the Transmission Control Protocol/Internet Protocol (TCP/IP) stack uses the local host table to resolve the static name for the server to the newly updated IP address that replaced the old or “stub” IP address stored in memory. The new IP address now corresponds to a domain name for a valid server located on the network. The NTP service may retrieve the current time from the new IP address and the IP-STB 200 may synchronize to this time. At step 420 the IP-STB 200 confirms proper synchronization. Proper synchronization confirmation may include comparing to a previously stored time or requesting a second time update through the NTP service and comparing the two requests. If the time cannot be synchronized then, returning to step 414, an error is reported to the user. At step 422, normal operation of the IP-STB is resumed.

As described earlier, the NTP service is a critical network service that may require a memory allocation during startup or booting. The IP-STB 200 may not include a battery that would maintain time even when no power has been provided. Further, periodic time updates may be important to continued operation and correction of time errors in the IP-STB 200. Therefore the NTP service may need to be launched during this initial step. However, correct operating information such as valid IP-addresses may not be available to the IP-STB 200 at start-up. Additionally the IP-STB 200 may not have direct internet access at start-up. Failure to launch the service may result in a requirement to re-boot the system once the information is obtained. By allowing the NTP service to launch but operate in an initially improper manner, the memory allocation is established, and updates through a restart operation can be provided. Further, any updates needed at a later time, due to for instance network reconfiguration, can be made also without requiring rebooting.

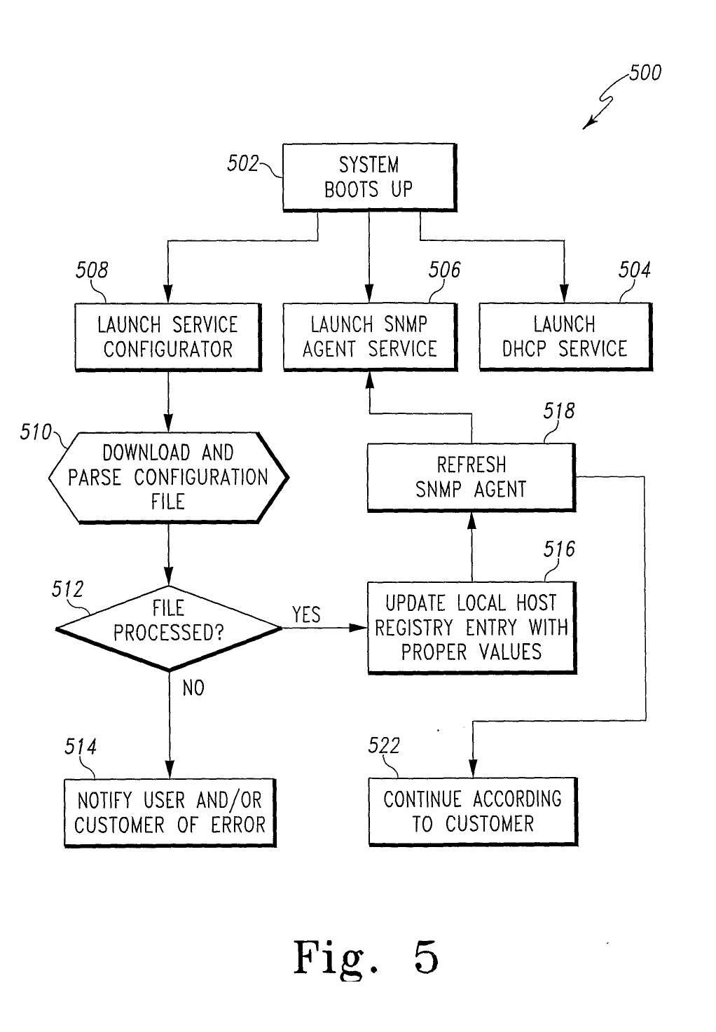

Turning now to FIG. 5 a flow chart of a further embodiment of a process 500 of the present invention is shown. FIG. 5 illustrates a process for updating the SNMP service. In the case of the SNMP service, information is provided allowing the service provider to create a more secure environment on the service provider's local network by controlling and restricting access to the network. The information may vary between service providers and, as a result, remains difficult to include in the IP-STB 200 during manufacturing. Unlike the NTP service, however, the information available in the standard DHCP options is insufficient to provide what is required for SNMP security.

The process starts from initial IP-STB turn-on or boot, however the flow chart may also accommodate conditions where services are already launched and running. At step 502, the network connected device begins an initial boot sequence. The boot sequence results in the launching of several services at steps 504, 506, and 508, including the DHCP service, the SNMP client service, and the service configurator respectively. The DHCP service sets up the IP processing stack and includes the IP address used in operation. The SNMP service provides, for instance, network security protocol information to the IP-STB 200. The service configurator is a resident service in the IP-STB 200 for managing operations and communications with the network. The configurator reads the options values returned from the network, updates the values and manages the updates. The configurator is also responsible for determining whether the services launched are properly operating. For instance, the configurator may initially determine that the SNMP service has launched but will not successfully operate until further information is downloaded from the network.

Launching the SNMP service during initial boot preserves the critical memory allocation within the operating system for proper operation. Initially the memory locations may be loaded with invalid or default information, allowing the SNMP service to launch but not operate in a proper manner. The improper operation will not hinder the remaining operations during initial boot, however, the operation may require correction prior to normal operation of the IP-STB 200.

Next, at step 510, a small configuration file is downloaded for information related to client applications. A configuration file is often downloaded from the network for providing updates if necessary and may include several more entries specific to services. These new entries include standard SNMP elements such as permitted managers and community names with respect to the network. At step 512, the file is processed to determine if any errors still exist. At step 514, the user is notified of these errors.

If no processing errors are found, at step 516, the information is entered into the registry portion of the memory in the appropriate locations based on operating system requirements with respect to the SNMP agent. Services such as SNMP may need to reside in the operating system and may not be stopped during boot as, for instance, the NTP service may be. Therefore, updating the SNMP service may not be handled in exactly the same manner as the NTP service. In order to accommodate updating the SNMP service, after the new information is entered, at step 518, the service is refreshed. The refresh operation involves re-initializing only the updated service without stopping the service or interrupting any other services. After refreshing, the process returns to step 506 and the service reverts to a normal condition now operating with the new information in place. At step 522, the IP-STB continues in normal operation.

As described earlier, the SNMP service is a critical network service that may require a memory allocation during startup or booting. Therefore the SNMP service may need to be launched during this initial step. However, correct operating information may not be available to the IP-STB at start-up. Failure to launch the service may result in a requirement to re-boot the system once the information is obtained. By allowing the SNMP service to launch but not necessarily operate in a proper manner, the memory allocation is preserved, and updates through a refresh operation can be provided. Further, any updates needed at a later time, due to for instance network reconfiguration, can be made also without requiring rebooting.

Additionally, a service such as SNMP may offer the capability to turn off or disable the built in agent or service. Since the service should not actually be stopped, the service provider may define the service as off and all SNMP entries in the registry are changed to point to known invalid IP addresses. Pointing to invalid IP addresses creates a state that operates effectively as disabled since no communication is available in or out of the box via the SNMP mechanism.

Although the embodiments described previously are focused on delivery of audio and video to a customer, the IP-STB 200 may also be used to deliver phone services to a customer. Phone service information may be provided to the IP-STB 200 through the local network in a manner similar to previously described. The phone information may then be provided to a phone jack such as an RJ-11 connector, not shown, on the IP-STB 200. The phone jack connects to a standard telephone handset and enables phone service through the IP-STB 200 as provided by the network service provider.

While the invention may be susceptible to various modifications and alternative forms, specific embodiments have been shown by way of example in the drawings and are described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of configuring a device comprising the steps of:
interfacing said device to a network;
launching a service related to interfacing said network to said device;
determining if said service is operating properly;
requesting information related to said service if said service is not operating properly; and
updating said service using said requested information without restarting said device.

2. The method set forth in claim 1, further comprising the step of storing said information related to said service in said device.

3. The method set forth in claim 1, wherein said service is included in an operating system of said device.

4. The method set forth in claim 1, wherein the step of updating said service further comprises refreshing said service while said service is launched.

5. The method set forth in claim 1, wherein the step of updating said service further comprises restarting said service.

6. The method set forth in claim 5, wherein the step of restarting said service further comprises the steps of:
stopping said service; and
starting said service immediately after stopping said service.

7. The method set forth in claim 1, wherein said service is a network management protocol service.

8. The method set forth in claim 1, wherein said service is a time protocol service.

9. The method set forth in claim 1, wherein the step of requesting information related to said service uses a dynamic host configuration protocol.

10. The method set forth in claim 1, wherein the step of determining if said service is operating properly uses a different service in said device.

11. An apparatus comprising:
a network interface for communicating with a network, said communication including a request for an update related to a service and an updated value related to said service;
a memory for storing a value related to said service; and
a processor operatively coupled to said network interface and said memory, said processor managing said update related to said service of said apparatus by changing said value related to said service to said updated value related to said service in said memory without restarting said apparatus.

12. The apparatus set forth in claim 11, wherein said service is a time protocol service.

13. The apparatus set forth in claim 11, wherein said service is a network management protocol service.

14. The apparatus set forth in claim 11, wherein said apparatus is used to display audio and video.

15. The apparatus set forth in claim 11, wherein said apparatus is a settop box.

16. The apparatus set forth in claim 11, wherein said network is a digital subscriber line network.

17. The apparatus set forth in claim 11, wherein said service is included in an operating system.

18. A device comprising:
means for interfacing a device to a network;
means for launching a service in an operating system of said device related to interface with said network;
means for requesting information related to said service; and
means for updating said service without restarting said operating system by storing said information into said device;

19. A method for providing configuration data to a network connected device comprising:
receiving a request for information related to a service launched in a device connected to said network; and
providing an update related to said service that permits updating said service in said device without restarting said device;

20. The method as claimed in claim 19, wherein said service is a network management protocol service.

21. The method as claimed in claim 19, wherein said service is a time protocol service.

22. The method as claimed in claim 19, wherein the step of receiving uses a dynamic host configuration protocol.
